(19) United States
(12) Patent Application Publication
(10) Pub. No.: US 2021/0390632 A1
(43) Pub. Date: Dec. 16, 2021

(54) SYSTEMS AND METHODS FOR REFERRAL MANAGEMENT AND TRACKING

(71) Applicant: Bungee LLC, Ponte Vedra Beach, FL (US)

(72) Inventor: James Carl Vaccarino, Ponte Vedra Beach, FL (US)

(21) Appl. No.: 17/343,706

(22) Filed: Jun. 9, 2021

Related U.S. Application Data
(60) Provisional application No. 63/037,726, filed on Jun. 11, 2020.

(51) Int. Cl. G06Q 50/00; G06Q 30/02; G06Q 10/10; G06Q 30/00; G06F 16/955; G06F 16/9535; H04L 29/08

(52) U.S. Cl. CPC G06Q 50/01; G06Q 30/0203; G06Q 10/1053; G06Q 30/016; H04W 4/20; G06F 16/9535; H04L 67/10; G06Q 30/0214; G06F 16/9558

(57) ABSTRACT

Systems and methods are disclosed for managing, distributing, and tracking various types of job postings and customer acquisition postings, and facilitating the referral of candidates by referral sources that may be interested in such postings. The referral sources can be rewarded for their referrals and be provided with updates regarding the referred candidate.

This application claims the benefit of U.S. Ser. No. 63/037,726, filed on Jun. 11, 2021, entitled SYSTEMS AND METHODS FOR REFERRAL MANAGEMENT AND TRACKING, this disclosure of which is incorporated herein in its entirety.

### BACKGROUND

### Background

Many companies utilize recruiting agencies to identify potential employees. Recruiters post job openings, collect resumes from prospective employees, and conduct initial interviews of the prospective employee. The recruiter then recommends one or more potential employees to the companies. This process, however, is often time-intensive and laborious for a recruiter. Moreover, beyond recruiting agencies, many other types of companies and entities rely on referrals for business development and customer acquisition purposes.

### BRIEF DESCRIPTION OF THE DRAWINGS

It is believed that certain embodiments will be better understood from the following description taken in conjunction with the accompanying drawings, in which like references indicate similar elements and in which:

FIG. 1 depicts a referral management computing system in accordance with one non-limiting embodiment.

FIGS. 2-3 depict example flow charts in accordance with various embodiments.

FIGS. 4-6 depict example simplified interfaces of a computing device in accordance with one non-limiting embodiment.

FIG. 7 depicts a referral management computing system in accordance with another non-limiting embodiment

### DETAILED DESCRIPTION

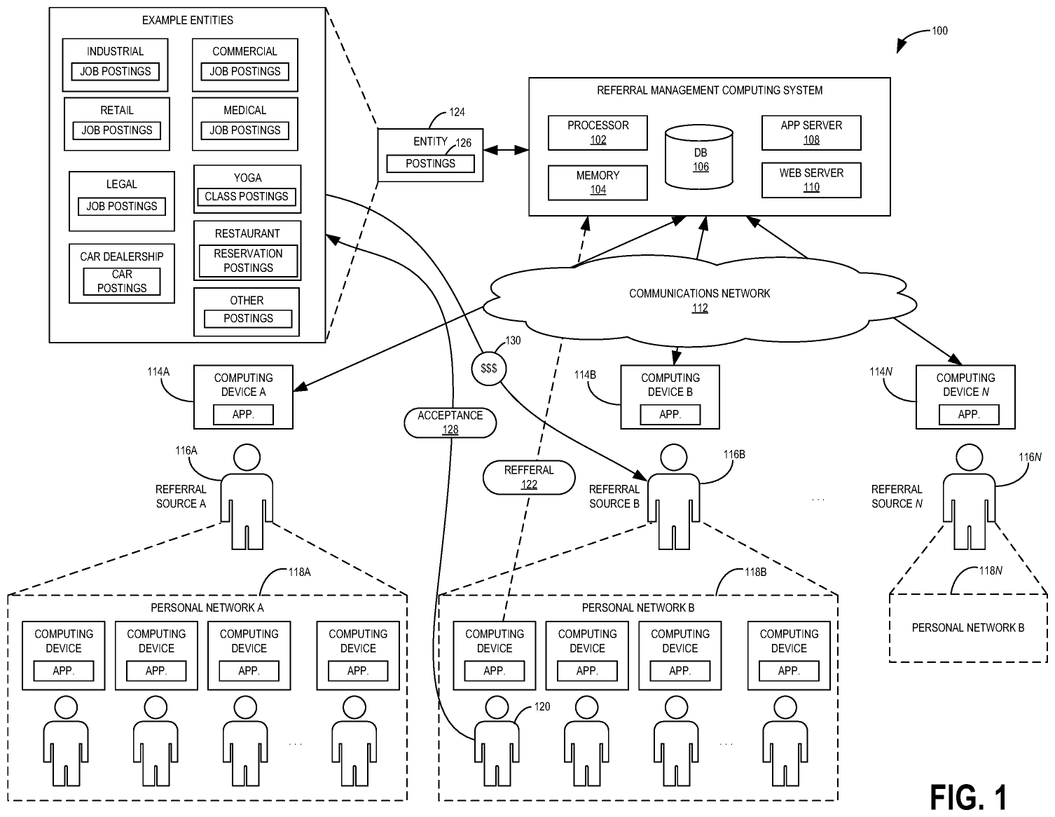

Various non-limiting embodiments of the present disclosure will now be described to provide an overall understanding of the principles of the structure, function, and use of systems, apparatuses, devices, and methods disclosed. One or more examples of these non-limiting embodiments are illustrated in the selected examples disclosed and described in detail with reference made to FIGS. 1-7 in the accompanying drawings. Those of ordinary skill in the art will understand that systems, apparatuses, devices, and methods specifically described herein and illustrated in the accompanying drawings are non-limiting embodiments. The features illustrated or described in connection with one non-limiting embodiment may be combined with the features of other non-limiting embodiments. Such modifications and variations are intended to be included within the scope of the present disclosure.

The systems, apparatuses, devices, and methods disclosed herein are described in detail by way of examples and with reference to the figures. The examples discussed herein are examples only and are provided to assist in the explanation of the apparatuses, devices, systems and methods described herein. None of the features or components shown in the drawings or discussed below should be taken as mandatory for any specific implementation of any of these apparatuses, devices, systems or methods unless specifically designated as mandatory. For ease of reading and clarity, certain components, modules, or methods may be described solely in connection with a specific figure. In this disclosure, any identification of specific techniques, arrangements, etc. are either related to a specific example presented or are merely a general description of such a technique, arrangement, etc. Identification of specific details or examples is not intended to be, and should not be, construed as mandatory or limiting unless specifically designated as such. Any failure to specifically describe a combination or sub-combination of components should not be understood as an indication that any combination or sub-combination is not possible. It will be appreciated that modifications to disclosed and described examples, arrangements, configurations, components, elements, apparatuses, devices, systems, methods, etc. can be made and may be desired for a specific application. Also, for any methods described, regardless of whether the method is described in conjunction with a flow diagram, it should be understood that unless otherwise specified or required by context, any explicit or implicit ordering of steps performed in the execution of a method does not imply that those steps must be performed in the order presented, but instead may be performed in a different order or in parallel.

Reference throughout the specification to “various embodiments,” “some embodiments,” “one embodiment,” “some example embodiments,” “one example embodiment,” or “an embodiment” means that a particular feature, structure, or characteristic described in connection with any embodiment is included in at least one embodiment. Thus, appearances of the phrases “in various embodiments,” “in some embodiments,” “in one embodiment,” “some example embodiments,” “one example embodiment, or “in an embodiment” in places throughout the specification are not necessarily all referring to the same embodiment. Furthermore, the particular features, structures or characteristics may be combined in any suitable manner in one or more embodiments.

Throughout this disclosure, references to components or modules generally refer to items that logically can be grouped together to perform a function or group of related functions. Like reference numerals are generally intended to refer to the same or similar components. Components and modules can be implemented in software, hardware, or a combination of software and hardware. The term “software” is used expansively to include not only executable code, for example machine-executable or machine-interpretable instructions, but also data structures, data stores and computing instructions stored in any suitable electronic format, including firmware, and embedded software. The terms “information” and “data” are used expansively and include a wide variety of electronic information, including executable code; content such as text, video data, and audio data, among others; and various codes or flags. The terms “information,” “data,” and “content” are sometimes used interchangeably when permitted by context. It should be noted that, although for clarity and to aid in understanding, some examples discussed herein might describe specific features or functions as part of a specific component or module, or as occurring at a specific layer of a computing device (for example, a hardware layer, operating system layer, or application layer), those features or functions may be implemented as part of a different component or module or operated at a different layer of a communication protocol stack. Those of ordinary skill in the art will recognize that the systems, apparatuses, devices, and methods described herein can be applied to, or easily modified for use with, other types of equipment, can use other arrangements of computing systems, and can use other protocols, or operate at other layers in communication protocol stacks, than are described.

As described in more detail below, the present disclosure generally relates to the management, tracking, and rewarding of referrals. The systems and methods described herein can be used in a wide variety of operational contexts. Thus, while certain examples are described in the context of employment recruiting agencies, this disclosure is not so limited. Instead, the systems and methods in accordance with the present disclosure can be used to assist with a wide variety of business development and customer acquisition opportunities.

Referring now to FIG. 1, one example embodiment of the present disclosure can comprise a referral management computing system 100. The referral management computing system 100 can be provided using any suitable processor-based device or system, such as a personal computer, laptop, server, mainframe, or a collection (e.g., network) of multiple computers, for example. The referral management computing system 100 can include one or more processors 102 and one or more computer memory units 104. For convenience, only one processor 102 and only one memory unit 104 are shown in FIG. 1. The processor 102 can execute software instructions stored on the memory unit 104. The processor 102 can be implemented as an integrated circuit (IC) having one or multiple cores. The memory unit 104 can include volatile and/or non-volatile memory units. Volatile memory units can include random access memory (RAM), for example. Non-volatile memory units can include read only memory (ROM), for example, as well as mechanical non-volatile memory systems, such as, for example, a hard disk drive, an optical disk drive, etc. The RAM and/or ROM memory units can be implemented as discrete memory ICs, for example.

The memory unit 104 can store executable software and data for the referral management computing system 100. When the processor 102 of the referral management computing system 100 executes the software, the processor 102 can be caused to perform the various operations of the referral management computing system 100. Data used by the referral management computing system 100 can be from various sources, such as a database(s) 106, which can be an electronic computer database, for example. The data stored in the database(s) 106 can be stored in a non-volatile computer memory, such as a hard disk drive, a read only memory (e.g., a ROM IC), or other types of non-volatile memory. In some embodiments, one or more databases 106 can be stored on a remote electronic computer system, for example. As is to be appreciated, a variety of other databases, or other types of memory storage structures, can be utilized or otherwise associated with the referral management computing system 100.

The referral management computing system 100 can also be in communication with a plurality of users, illustrated as referral sources 116A-N via their user computing devices 114A-N through a communications network 112. The referral management computing system 100 can communicate with the various user computing devices 114A-N via a number of computer and/or data networks, including the Internet, LANs, WANs, GPRS networks, etc., that can comprise wired and/or wireless communication links.

The computing devices 114A-N can be any type of computer device suitable for communication with the referral management computing system 100 over the network 112, such as a wearable computing device, a mobile telephone, a tablet computer, a device that is a combination handheld computer and mobile telephone (sometimes referred to as a “smart phone”), a personal computer (such as a laptop computer, netbook computer, desktop computer, and so forth), or any other suitable mobile communications device, such as personal digital assistants (PDA), tablet devices, gaming devices, or media players, for example.

The computing devices 114A-N can, in some embodiments, provide a variety of applications for allowing the referral sources 116A-N to accomplish one or more specific tasks using the referral management computing system 100. Applications can include, without limitation, a web browser application (e.g., INTERNET EXPLORER, MOZILLA, FIREFOX, SAFARI, OPERA, NETSCAPE NAVIGATOR) telephone application (e.g., cellular, VoIP, PTT), networking application, messaging application (e.g., e-mail, IM, SMS, MMS), social media applications, and so forth. The computing devices 114A-N can comprise various software programs such as system programs and applications to provide computing capabilities in accordance with the described embodiments. System programs can include, without limitation, an operating system (OS), device drivers, programming tools, utility programs, software libraries, application programming interfaces (APIs), and so forth. Exemplary operating systems can include, for example, a PALM OS, MICROSOFT OS, APPLE OS, ANDROID OS, UNIX OS, LINUX OS, SYMBIAN OS, EMBEDIX OS, Binary Run-time Environment for Wireless (BREW) OS, JavaOS, a Wireless Application Protocol (WAP) OS, and others.

The computing devices 114A-N can include various components for interacting with the referral management computing system 100. The computing devices 114A-N can include components for use with one or more applications such as a stylus, a touch-sensitive screen, keys (e.g., input keys, preset and programmable hot keys), buttons (e.g., action buttons, a multidirectional navigation button, preset and programmable shortcut buttons), switches, a microphone, speakers, an audio headset, and so forth.

The referral sources 116A-N can interact with the referral management computing system 100 via a variety of other electronic communications techniques, such as, without limitation, HTTP requests, in-app messaging, and short message service (SMS) messages. The electronic communications can be generated by a specialized application executed on the computing devices 114A-N or can be generated using one or more applications that are generally standard to the user computing device 114A-N. The applications can include, or be implemented as, executable computer program instructions stored on computer-readable storage media such as volatile or non-volatile memory capable of being retrieved and executed by a processor to provide operations for the computing devices 114A-N.

As shown in FIG. 1, the referral management computing system 100 can include several computer servers and databases. For example, the referral management computing system 100 can include one or more application servers 108, web servers 110, and/or any other type of servers. For convenience, only one application server 108 and one web server 110 are shown in FIG. 1, although it should be recognized that the disclosure is not so limited. The servers can cause content to be sent to the computing devices 114A-Nin any number of formats, such as text-based messages, multimedia message, email messages, smart phone notifications, web pages, and so forth. The servers 108 and 110 can comprise processors (e.g., CPUs), memory units (e.g., RAM, ROM), non-volatile storage systems (e.g., hard disk drive systems), etc. The servers 108 and 110 can utilize operating systems, such as Solaris, Linux, or Windows Server operating systems, for example.

The web server 110 can provide a graphical web user interface through which various users of the system can interact with the referral management computing system 100. The web server 110 can accept requests, such as HTTP requests, from clients (such as via web browsers on the computing devices 114A-/V), and serve the clients responses, such as HTTP responses, along with optional data content, such as web pages (e.g., HTML documents) and linked objects (such as images, video, and so forth).

The application server 108 can provide a user interface for users who do not communicate with the referral management computing system 100 using a web browser. Such users can have special software installed on their computing devices 114A-N that allows them to communicate with the application server 108 via the network. Such software can be downloaded, for example, from the referral management computing system 100, or other software application provider, over the network to such computing devices 114A-N.

As shown, each of the referral sources 116A-N can be associated with their own personal network 118A-N, which can include, for example, friends, family, co-workers, colleagues, and so forth. As schematically illustrated, each person in the various personal networks can be associated with a computer device (such as a laptop computer, desktop computer, tablet computer, smart phone, etc.), which can be used to communicate with the referral management computing system 100, as may be needed.

Still referring to FIG. 1, an entity 124 can submit postings 126 to the referral management computing system 100. The type of posting 126 can vary based on implementation and type of entity 124. By way of non-limiting examples, the postings 126 can be open employment positions for which job applicants are sought. Such employment positions can be in any of a variety of industries or sectors, such as, without limitation, industrial, retail, legal, commercial, medical, and so forth. Additionally or alternatively, the postings 126 can be associated with business development or customer acquisition. By way of non-limiting examples, the postings 126 can be work-out or fitness classes, restaurant reservations, and/or sales related postings (automobiles, real estate, personal property, etc.), among a wide variety of other types of postings.

The referral management computing system 100 can distribute various postings 126 to one or more of referral sources 116A-N via their respective computing devices 114A-N. For example, if a posting 126 is an employment posting for an attorney in a particular geographic area, the referral management computing system 100 can determine which of the referral sources 116A-N may know of people within their personal networks 118A-N who could be potential candidates for the posting. In the illustrated embodiment, for example, referral source 116B is an attorney in the same geographic area as the posting 126. As such, the referral management computing system 100 can provide the posting 126 to the computing device 114B of the referral source 116B. For example, the posting 126 can be sent to a mobile application executing on the computing device 114B.

Upon consideration of the posting 126, the referral source 116B can determine if they know anyone that might be a good fit. In the illustrated embodiment, the referral source 116B has determined that referred candidate 120 may be a good match for the position. As such, through interactions with the mobile application executing on the computing device 114B, the referral source 116B can identify the referred candidate 120 to the referral management computing system 100 via a referral 122. The referral 122 can include, for example, contact information for the referred candidate 120.

Upon receiving the contact information for the referred candidate 120, the referral management computing system 100 can send communications to the referred candidate 120 via any suitable communications means, such as an email message, a text message, a telephone call, a social media message, and so forth. In some embodiments, the referred candidate 120 is instructed to download an application for execution on their computing device. Additionally or alternatively, the referred candidate 120 can be directed to a website or other portal to allow communication between the referred candidate 120 and the referral management computing system 100. In some embodiments, the referred candidate 120 can be requested to complete a survey or questionnaire so that initial screening can be performed. In this regard, for example, the referred candidate 120 can supply information to the referral management computing system 100 that can be used to determine if the referred candidate 120 could be a match for the posting 126. For instance, in some implementations, the referred candidate 120 is instructed to complete an online or in-app survey that is scored by the referral management computing system 100. In order for the referred candidate 120 to continue with the process, their score must be above a certain threshold, for example.

If the referred candidate 120 moves through an interview process, the referral management computing system 100 can update the referral source 116B to keep them informed. By way of non-limiting examples, the referral source 116B can receive an alert, notification, or other type of message when the referred candidate 120 has an interview, if an offer is extended, if the other is accepted, and so forth. In FIG. 1, the referred candidate 120 is schematically shown accepting an offer, as indicated by acceptance 128. Based on the acceptance 128, and the completion of any other suitable conditions, a referral fee 130 can be paid to the referral source 116B.

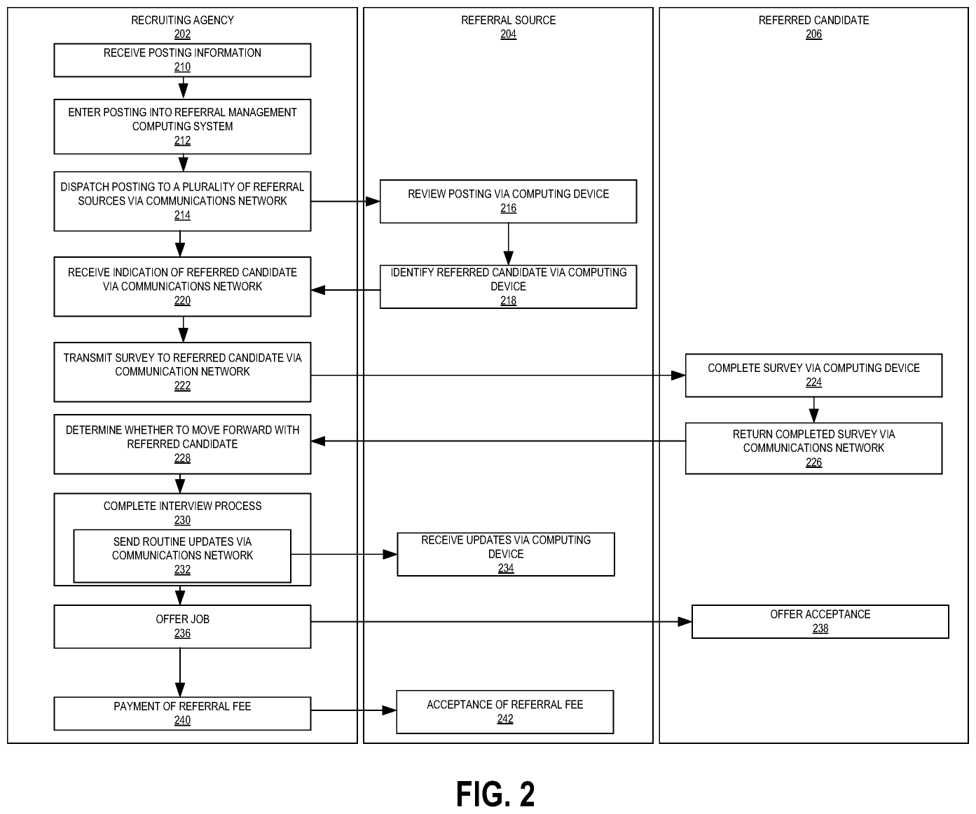

Referring now to FIG. 2, an example flow chart is depicted. For illustration purposes, a recruiting agency 202 is shown. It is to be appreciated, however, that this disclosure is not so limited. Instead, any company or entity wishing to increase and incentivize referrals can leverage the systems and methods described herein. At 210, the recruiting agency 202 receives posting information. Such posting information can include, for example, a job description, a geographic location, a salary range, candidate requirements, and so forth. At 212, the posting can be entered into a referral management computing system, similar to referral management computing system 100 of FIG. 1, for example. At 214, the posting can be dispatched to a plurality of referral sources via a communications network. As is to be appreciated, the particular referral sources that receive the posting can be based on any number of qualifying factors, such as the geographic location of the referral source, the occupation/vocation of the referral source, the job title of the referral source, and so forth. As shown, at 216, a referral source 204 can review the posting to determine if they know anyone that might be a good fit for the posting. At 218, the referral source 204 can identify a potential candidate via their computing device.

At 220, the recruiting agency 202 can receive an indication of the referred candidate via communications network. In some embodiments, at 222, the recruiting agency 202 can transmit a survey to the referred candidate 206. At 224, the referred candidate 206 can complete the survey via a computing device. The survey can be any suitable type of questionnaire or screening form. Further, the survey can be an online survey, an in-app survey, an automated telephone survey, among a variety of other types of data gathering techniques. At 226, the completed survey can be returned to the recruiting agency 202 by the referred candidate 206.

At 228, the recruiting agency 202 can determine whether to move forward with the referred candidate 206. Such determination can be based, at least in part, on the results of the survey, although this disclosure is not so limited. At 230, based on the decision to move forward, an interview process can be completed. At 232 and 234, various updates can be provided to the referral source 204. The updates can keep the referral source 204 apprised of the interviewing process as the referred candidate 206 reaches various milestones (i.e., phone interview, in-person interview, call-back interview, job offer, and so forth). At 236, a job offer is extended to the referred candidate 206, which is accepted by the referred candidate 206 at 238. At 240, a payment of a referral fee can be made to the referral source 204. At 242, the referral source 204 can accept the payment. As to be appreciated, the referral fee can be withheld until certain conditions are satisfied, such as the referred candidate 206 completing 6 months or 12 months of employment, for example.

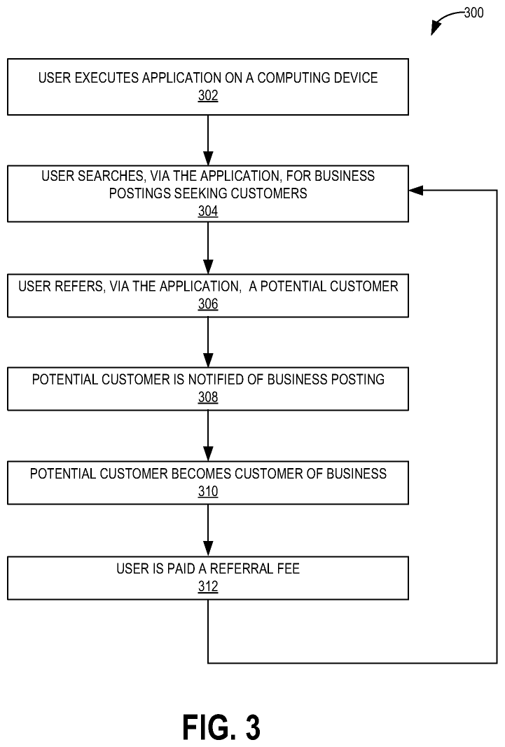

Referring now to FIG. 3, an example flow chart 300 is depicted. At 302, a user executes an application on a computing device. At 304, the user searches, via the application, for business postings seeking customers. Such businesses can be any type of business, entity, group, club, or organization that is in need of customers, patrons, participants, etc. At 306, via the application, the user can refer a potential customer to one of the postings. At 308, the potential customer can be notified of the business posting. At 310, the potential customer can become a customer of the business. At 312, the user that originally referred the potential customer can be paid a referral fee.

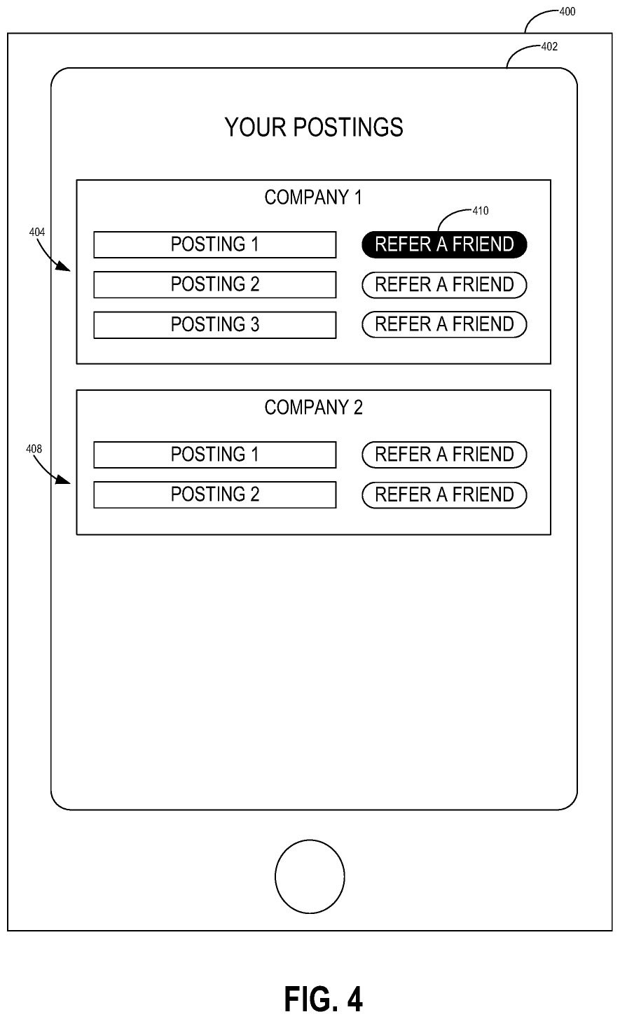

Referring now to FIGS. 4-6, simplified example interfaces 402 of a user computing device 400 are depicted. While the computing device 400 is schematically shown as a smart phone, it is to be readily apparent that the user computing device 400 can be any suitable device having network communication capabilities, such as a laptop computer, desktop computer, tablet computer, and so forth. Furthermore, while the interfaces 402 schematically depict a specialized application for illustration purposes, it is to be appreciated that, additionally or alternatively, similar interfaces can be provided by webpages.

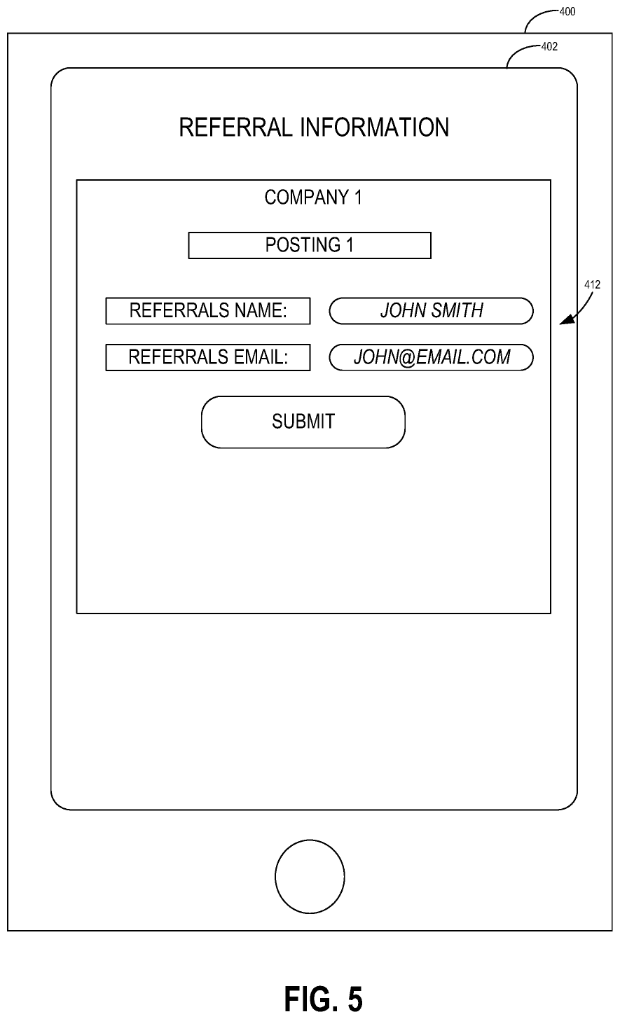

Referring first to FIG. 4, the example interface 402 is shown presenting a set of postings 404 for Company 1 and a set of postings 408 for Company 2. The scope or type of the positions can vary, but in some embodiments, the postings can be job openings. Additionally or alternatively, the postings can be regarding businesses seeking customers, members, or participants, for example. For purposes of illustration, the postings 404 and 408 are job postings. The user of the computing device 400 can optionally refer a friend to any of the postings. As shown by selection 410, the user has opted to refer a friend to the first posting listed for Company 1. Upon make the selection 410, the user can be requested to supply additional information regarding the referred candidate, as shown in FIG. 5. In some embodiments, for example, referred candidate information 412 can include their name, email address, and so forth. As described above, the referred candidate can be contacted, screened, and potentially begin the interview process.

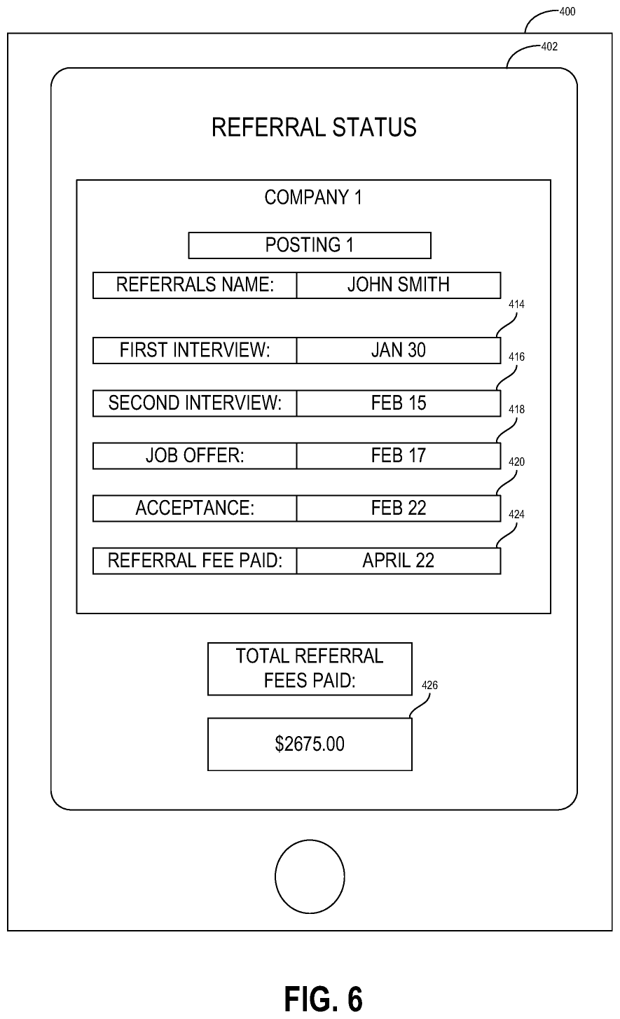

As shown by FIG. 6, the user of the computing device 400 can be kept apprised of the status of the process. By way of non-limiting example, with regard to the candidate that they referred, the user was informed of each of the following milestones: first interview 414, second interview 416, job offer 418, and acceptance 420. As shown, a referral fee 424 was paid to the user. The example interface 402 in FIG. 6 also shows a running total 426 of all referral fees paid to the user.

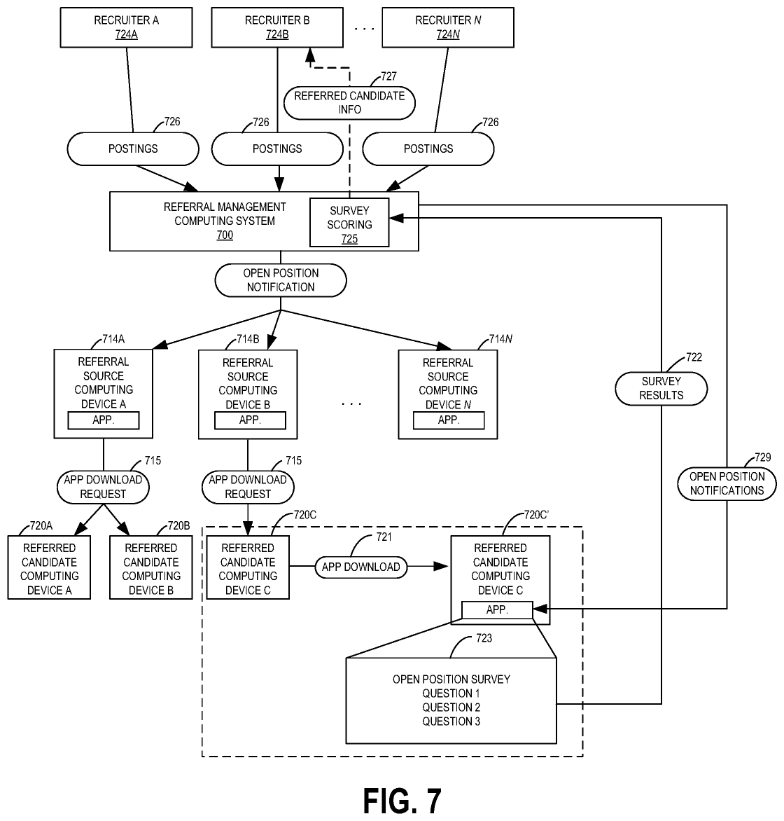

Referring now to FIG. 7, another example referral management computing system 700 is depicted. The referral management computing system 700 can be similar in many aspects to the referral management computing system 100, as depicted in FIG. 1, for example. Various recruiters 724A-N can submit postings 726 to the referral management computing system 700. The recruiters 724A-N can be affiliated with the same recruiting agency or different recruiting agencies, for example. The postings 726 can be, for example, open job positions that have the employment requirements set. Based on the postings 726, the referral management computing system 700 can send open position notification(s) 713 to the network of referral source computing devices 714A-N. The open position notification(s) 713 can be sent to an entire user group, or only to certain users, for example. Such referral source computing devices 714A-N can be, for example, associated with users that have downloaded and installed a specialized application on their referral source computing device 714A-N, and/or otherwise have access the referral management computing system 100 through other techniques, such as accessing an account on a web-based portal.

One or more of the users of the referral source computing devices 714A-N can review the open position notification(s) 713 and determine whether someone in their personal network may be a good match for the open position. If so, the users can send an application download request 715 to referred candidate computing devices 720A-C, for example. The application download request 715 can be, for example, an email with download or access information, a text message with download or access information, a social media message with download or access information, among a variety of other formats and techniques for allowing users of the referred candidate computing devices 720A-C to access the referral management computing system 100.

In the illustrated example, referred candidate computing device 720C is schematically shown downloading and installing the application 721. Referred candidate computing device 720C′ can access the referral management computing system 100. In some embodiments, the referred candidate can be requested by the referral management computing system 100 to complete a survey 723 or other form or questionnaire. The survey 723 can assist the referral management computing system 100 in determining whether the referred candidate may be a good match for the open position, as well as allow the referral management computing system 100 to receive additional biographical and employment-related information from the referred candidate.

In some embodiments, the survey results 722 can be sent to a scoring function 725 of the referral management computing system 100 to be scored or otherwise processed. The scoring function 725 can compare, for example, the survey results 722 to the particular requirements of one of the postings 726. If the comparison is favorable, the referral management computing system 100 can forward along the referred candidate to the recruiter for further processing.

Even if, however, the referred candidate is not a favorable match to the posting, the referred candidate is now beneficially on-boarded into the referral management computing system 100. Accordingly, the referral management computing system 100 can leverage the information it now has about the referred candidate to send other open position notifications 729 directly to the referred candidate computing device 720C′. Upon receipt, the user can decide to pursue the open position, or the user can determine if anyone in their personal network may be a good match. If so, an application download request can be sent to that person or people (similar to application download request 715, for example). Additionally or alternatively, other notifications 731 can also be sent to the referred candidate computing device 720C′ by the referral management computing system 100. Such other notifications 731 can include, for example, other requests for customer referrals, business development notifications, coupons, offerings, or other alerts or messaging that may be of interest to the user of the referred candidate computing device 720C′.

The foregoing description of embodiments and examples has been presented for purposes of description. It is not intended to be exhaustive or limiting to the forms described. Numerous modifications are possible in light of the above teachings. Some of those modifications have been discussed and others will be understood by those skilled in the art. The embodiments were chosen and described for illustration of various embodiments. The scope is, of course, not limited to the examples or embodiments set forth herein, but can be employed in any number of applications and equivalent articles by those of ordinary skill in the art. Rather it is hereby intended the scope be defined by the claims appended hereto.

What is claimed is:

1. A referral management system, comprising:
a referral management computing system comprising one or more processors and non-transitory computer readable medium having instructions stored thereon, which when executed by at least one of the one or more processors, cause the referral management computing system to:
store profiles for each of a plurality of referral sources, wherein each of the referral sources is associated with a respective referral source computing device;
receive a posting from an entity via network communications;
distribute the posting to one or more referral source computing devices via network communications;
receive an identity of a referred candidate from one of the referral source computing devices via network communications;
send an electronic communication to a computing device of the referred candidate, wherein the electronic communication comprises an inquiry;
receive from the computing device of the referred candidate at answer to the inquiry; and
provide at least receive an identify of a referred candidate from one of the referral source computing devices via network communications.

2. The referral management system of claim 1, wherein the instructions further cause the referral management computing system to:
provide at least one update regarding the referred candidate to the referable source computing device that provided the identity of the referred candidate.

3. The referral management system of claim 1, where the identity of a referred candidate comprises contact information.

4. The referral management system of claim 3, wherein the contact information is any of an email address and a telephone number.

5. The referral management system of claim 1, wherein the electronic communication sent to the computing device of the referred candidate comprise a web link to download a mobile application.

6. The referral management system of claim 1, wherein the instructions further cause the referral management computing system to:
based on the answer to the inquiry, determine a score for the referred candidate.

7. The referral management system of claim 6, wherein the instructions further cause the referral management computing system to:
determine whether to identify the referred candidate to the entity based on the score.

8. The referral management system of claim 1, wherein the entity is any of an industrial entity, a retail entity, a legal entity, a car dealership entity, a commercial entity, a medical entity, a yoga entity, and a restaurant entity.

9. The referral management system of claim 1, wherein the posting is a job posting.

10. The referral management system of claim 1, wherein the posting is a customer acquisition posting.

11. A computer-based method of referral management, comprising:
storing, by a referral management computing system, profiles for each of a plurality of referral sources, wherein each of the referral sources is associated with a respective referral source computing device;
receiving, by the referral management computing system, a posting from an entity via network communications;
distributing, by the referral management computing system, the posting to one or more referral source computing devices via network communications;
receiving, by the referral management computing system, an identity of a referred candidate from one of the referral source computing devices via network communications;
sending, by the referral management computing system, an electronic communication to a computing device of the referred candidate, wherein the electronic communication comprises an inquiry;
receiving, by the referral management computing system, from the computing device of the referred candidate at answer to the inquiry; and
providing, by the referral management computing system, at least receive an identify of a referred candidate from one of the referral source computing devices via network communications.

12. The computer-based method of claim 11, further comprising
providing, by the referral management computing system, at least one update regarding the referred candidate to the referable source computing device that provided the identity of the referred candidate.

13. The computer-based method of claim 11, where the identity of a referred candidate comprises contact information and the contact information is any of an email address and a telephone number.

14. The computer-based method of claim 11, wherein the electronic communication sent to the computing device of the referred candidate comprise a web link to download a mobile application.

15. The computer-based method of claim 11, further comprising:
based on the answer to the inquiry, determining, by the referral management computing system, a score for the referred candidate; and
determining, by the referral management computing system, whether to identify the referred candidate to the entity based on the score.

16. The computer-based method of claim 11, wherein the entity is any of an industrial entity, a retail entity, a legal entity, a car dealership entity, a commercial entity, a medical entity, a yoga entity, and a restaurant entity.

17. The computer-based method of claim 11, wherein the posting is a job posting.

18. The computer-based method of claim 11, wherein the posting is a customer acquisition posting.

19. A computer-based method of referral management tracking, the method performed by one or more computing devices comprising instructions stored in a memory, which when executed by one or more processors of the one or more computing devices, cause the one or more computing devices to perform the method comprising:
storing profiles for each of a plurality of referral sources, wherein each of the referral sources is associated with a respective referral source computing device;
receiving a posting from an entity via network communications;
distributing the posting to one or more referral source computing devices via network communications;
receiving an identity of a referred candidate from one of the referral source computing devices via network communications;
sending an electronic communication to a computing device of the referred candidate, wherein the electronic communication comprises an inquiry;
receiving from the computing device of the referred candidate at answer to the inquiry;
providing at least receive an identify of a referred candidate from one of the referral source computing devices via network communications; and
providing at least one update regarding the referred candidate to the referable source computing device that provided the identity of the referred candidate.

20. The computer-based method of claim 19, wherein distributing the posting to one or more referral source computing devices via network communications comprises any of distributing the posting via an email communication and distributing the posting to a mobile application.
